(19) United States
(12) Patent Application Publication
(10) Pub. No.: US 2009/0267563 A1
(43) Pub. Date: Oct. 29, 2009

(54) ELECTRONIC DEVICE

(75) Inventors: LUNG DAI, Tu-Cheng (TW); WANG-CHANG DUAN, Shenzhen City (CN); ZHI-PENG MA, Shenzhen City (CN); BANG-SHENG ZUO, Shenzhen City (CN)

Correspondence Address: PCE INDUSTRY, INC.;ATT. Steven Reiss, 288 SOUTH MAYO AVENUE, CITY OF INDUSTRY, CA, 91789, US

(73) Assignees: HONG FU JIN PRECISION (ShenZhen) CO., LTD., Shenzhen City (CN); HON HAI PRECISION INDUSTRY CO., LTD., Tu-Cheng (TW)

(21) Appl. No.: 12/325,280

(22) Filed: Dec. 1, 2008

(30) Foreign Application Priority Data
Apr. 28, 2008 (CN) 200810301363.3

(51) Int. Cl. H02J 7/00

(52) U.S. Cl. 320/114

(57) ABSTRACT

An electronic device includes a remote control and a main body. The remote control has two contacting portions. The main body is capable of being controlled by the remote control. The main body has two conductive portions and two power supply terminals for supplying the electrical power to the two conductive portions. The contacting portions of the remote control detachably electrically connect with the conductive portions for charging the remote control.

### BACKGROUND

1. Technical Field

The present disclosure relates to an electronic device, and more particularly to an electronic device with a remote control.

2. Description of Related Art

An electronic device such as a portable digital versatile disk (DVD) player includes a remote control for remotely operating the electronic device.

Most remote control devices are powered by a battery. When the battery is dead the remote control cannot be used until the battery is replaced.

Therefore, improved electronic device is needed to address the aforementioned deficiencies and inadequacies.

### BRIEF DESCRIPTION OF THE DRAWINGS

FIG. 1 is an isometric view of an electronic device in accordance with an exemplary embodiment, the electronic device including a remote control.

FIG. 2 is a partially exploded view of the electronic device in FIG. 1.

FIG. 3 is an isometric view of the remote control in FIG. 2.

FIG. 4 is a circuit diagram of the mechanical switch in FIG. 2.

### DETAILED DESCRIPTION OF THE EXEMPLARY EMBODIMENTS

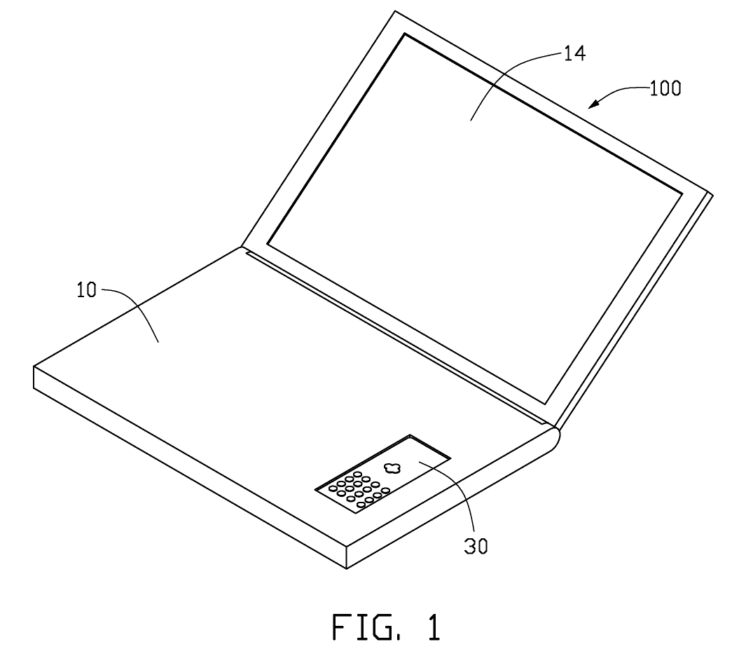

Referring to FIG. 1, an electronic device 100 includes a remote control 30, a main body 10 for accommodating the remote control 30, and a cover 14 pivotably connected to the main body 10.

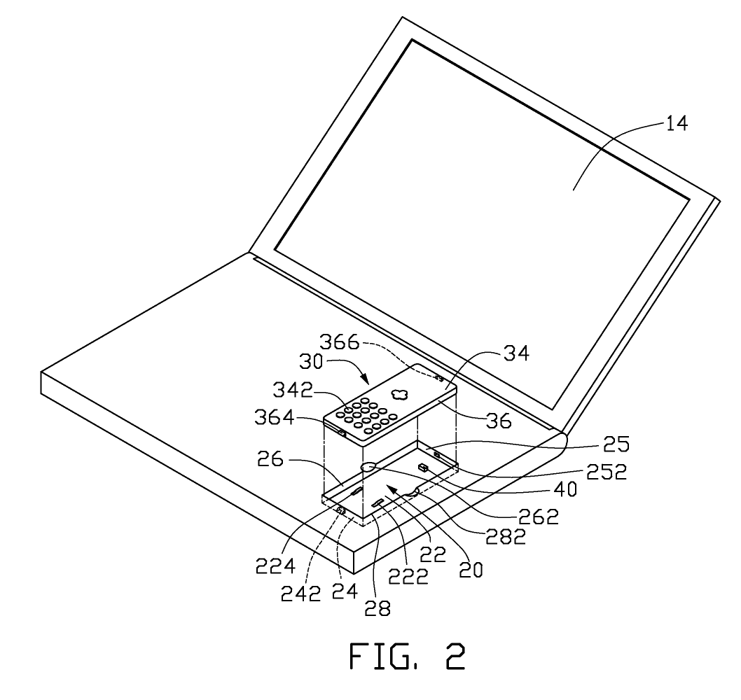

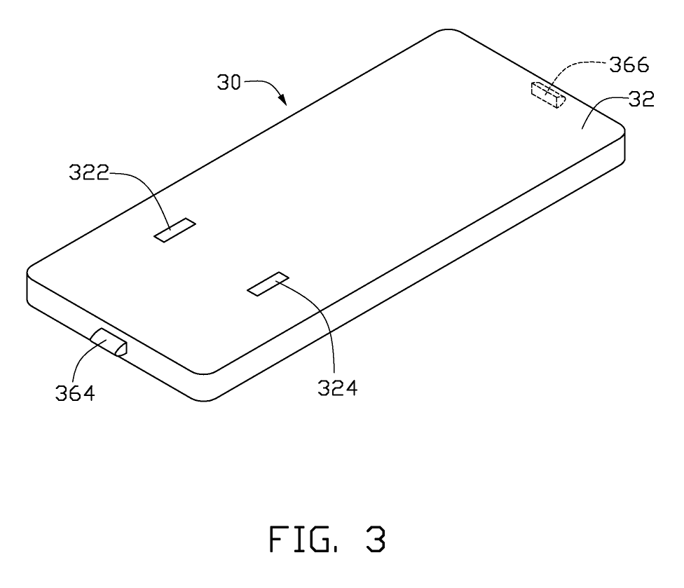

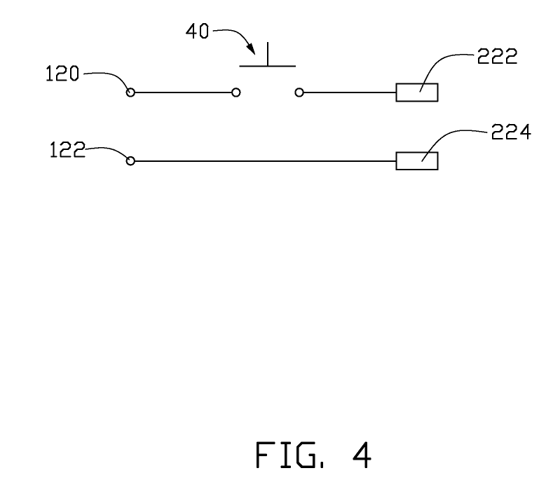

Referring to FIGS. 2 to 4, the remote control 30 is a hexahedron in shape. The remote control 30 has a first surface 34, a second surface 32 opposite to the first surface 34 and four side surfaces 36 connecting between the first surface 34 and the second surfaces 32. The four side surfaces 36 are interconnected with each other.

A plurality of keys 342 for controlling the main body 10 are disposed on the first surface 34. Two contacting portions 322, 324 are disposed on the second surface 32. Two protrusions 364, 366 are respectively disposed at two opposite side surfaces 36.

The main body 10 includes a receiving portion 20 for accommodating the remote control 30. When the remote control 30 is not used, the remote control 30 can be placed in the receiving portion 20 of the main body 10, to lower the probability of losing/misplacing the remote control 30.

The receiving portion 20 has a quadrangular bottom surface 22 and four sidewalls 24, 26, 25, 28 respectively extending upward from four edges of the bottom surface 22. The four sidewalls 24, 26, 25, 28 are interconnected with each other. The bottom surface 22 faces the second surface 32 of the remote control 30 when the remote control 30 is received in the main body 10.

Two conductive portions 222, 224 are disposed at the bottom surface 22 of the receiving portion 20 corresponding to the two contacting portions 322, 324.

Two power supply terminals 120, 122 are disposed in an internal circuit board (not shown) of the main body 10 for receiving electrical power from a power supply (not shown).

A mechanical switch 40 is disposed at the bottom surface 22 and electrically connected between the power supply terminal 120 and the conductive portion 222. The mechanical switch 40 has two states; an open state, and a close state. When the switch is in the close state, the switch closes an electrical circuit between the supply terminal 120 and the conductive portion 222, i.e., when the switch is in the close state, an electrical connection between the supply terminal 120 and the conductive portion 222 is established. In the open state, the electrical connection between the supply terminal 120 and the conductive portion 222 is discontinued.

When the remote control 30 is placed in the receiving portion 20 of the main body 10, the remote control 30 actuates the mechanical switch 40 to be in the close state, thus, the electrical connection between the power supply terminal 120 and the conductive portion 222 is established. The conductive portions 222, 224 electrically connect with the contacting portion 322, 324 correspondingly. The two power supply terminals 120, 122 can supply the electrical power received from the power supply to the two conductive portions 322, 324, and two contacting portions 222, 224, thereby, charging the remote control 30.

Two openings 242, 252 corresponding to the two protrusions 364, 366 are respectively defined on the two opposite sidewalls 24, 25 of the receiving portion 20. The two openings 242, 252 can be correspondingly engaged by the two protrusions 364, 366 to fix the remote control 30 in the receiving portion 20. Therefore, the probability of the remote control 30 falling out is decreased.

Two notches 262, 282 are respectively defined at substantially central portions of the two opposite sidewalls 26, 28 of the receiving portion 20. When the remote control 30 has been charged, or needs to be used for controlling the main body 10, the remote control 30 can be conveniently retrieved from the receiving portion 20 by exerting a force at the bottom surface 32 through the notches 262, 282.

It is to be understood, however, that even though numerous information and advantages of the present disclosure have been set forth in the foregoing description, together with details of the structure and function of the present disclosure, the present disclosure is illustrative only, and changes may be made in detail, especially in matters of shape, size, and arrangement of parts within the principles of the present disclosure to the full extent indicated by the broad general meaning of the terms in which the appended claims are expressed.

1. An electronic device, comprising:
a remote control having two contacting portions;
a main body capable of being controlled by the remote control, the main body having two conductive portions and two power supply terminals for supplying electrical power to the two conductive portions, and
a switch capable of being operated between a closed state and an open state, the switch being electrically connected between one of the two power supply terminals and one of the two conductive portions;
wherein the contacting portions of the remote control can be detachably electrically connected with the conductive portions for charging the remote control, when the remote control presses the switch, the switch is in the closed state, the electrical connection between the two power supply terminals and the two conductive portions is established such that the remote control is charged by the electrical power supplied from the two power supply terminals; and when the remote control does not press the switch, the switch is in the open state, the electrical connection between the two power supply terminals and the two conductive portions is discontinued.

2-4. (canceled)

5. The electronic device according to claim 1, wherein the main body defines a receiving portion for accommodating the remote control.

6. The electronic device according to claim 5, wherein the main body defines a notch at a sidewall of the receiving portion.

7. The electronic device according to claim 5, wherein the remote control and the main body respectively defined a protrusion and an opening capable of being engaged by the protrusion thereon.

8. An electronic device capable of being controlled by a remote control, the electronic device comprising:
a cover; and
a main body pivotably connected to the cover, the main body defining a receiving portion for removably accommodating the remote control in the receiving portion;
wherein the main body is disposed with a mechanical switch in the receiving portion, the mechanical switch is capable of being pressed by the remote control to establish an electrical connection between the main body and the remote control for transmitting electrical power from the main body to the remote control, the remote control is also capable of being de-actuated by the remote control after the remote control being removed from the receiving portion.

9. The electronic device according to claim 8, wherein the remote control is engageably received in the receiving portion by inserting a protrusion disposed on the remote control into and an opening defined in the receiving portion.

10. The electronic device according to claim 8, wherein the main body defines two notches at two opposite sidewalls of the receiving portion.
